(19) United States
(12) Patent Application Publication
(10) Pub. No.: US 2020/0016623 A1
(43) Pub. Date: Jan. 16, 2020

(54) SUBSTRATE PROCESSING METHOD, SUBSTRATE PROCESSING APPARATUS, AND STORAGE MEDIUM

(71) Applicant: Tokyo Electron Limited, Tokyo (JP)

(72) Inventor: Hiromitsu Nanba, Kumamoto (JP)

(21) Appl. No.: 16/504,473

(22) Filed: Jul. 8, 2019

(30) Foreign Application Priority Data
Jul. 10, 2018 (JP) 2018-130965

(51) Int. Cl. B05C 5/00; C23F 1/16; C23F 1/02; C23F 1/08

(52) U.S. Cl. CPC B05C 5/002; C23F 1/08; C23F 1/02; C23F 1/16

(57) ABSTRACT

A substrate processing method according to an exemplary embodiment includes: supplying, to a peeling target portion which is at least a portion of a coating film including a first coating film and a second coating film, a chemical liquid for enhancing a peeling performance between the first coating film and the second coating film, the first coating film being formed on a surface of a substrate, the second coating film being formed on the first coating film and containing carbon with a different composition from that of the first coating film; amplifying a temperature fluctuation of the peeling target portion to which the chemical liquid has been supplied; and supplying a rinse liquid for removing the second coating film to the peeling target portion after the amplification of the temperature fluctuation.

### CROSS-REFERENCE TO RELATED APPLICATIONS

The present application is based on and claims priority from Japanese Patent Application No. 2018-130965, filed on Jul. 10, 2018, with the Japan Patent Office, the disclosure of which is incorporated herein in its entirety by reference.

### TECHNICAL FIELD

Exemplary embodiments of the present disclosure relate to a substrate processing method, a substrate processing apparatus, and a storage medium.

### BACKGROUND

Japanese Patent Laid-Open Publication No. 2017-117938 discloses a substrate processing method that includes the following three steps, as a method of removing an organic film such as an amorphous carbon film. The first step is a step of storing sulfuric acid in the bottom of the processing tank and forming a sulfuric acid layer which is a liquid layer composed of sulfuric acid, in the processing tank. The second step is a reaction layer formation step of supplying hydrogen peroxide water onto a sulfuric acid layer, and as a result, forming a reaction layer which is a liquid layer where sulfuric acid and hydrogen peroxide water exist, and a reaction between sulfuric acid and hydrogen peroxide occurs, on the sulfuric acid layer. The third step is a passing step of causing a substrate to pass through the reaction layer in a state of standing upright.

### SUMMARY

According to an exemplary embodiment, a substrate processing method comprising: supplying, to a peeling target portion which is at least a portion of a coating film including a first coating film and a second coating film, a chemical liquid for enhancing a peeling performance between the first coating film and the second coating film, the first coating film being formed on a surface of a substrate, and the second coating film being formed on the first coating film and containing carbon with a different composition from that of the first coating film; amplifying a temperature fluctuation of the peeling target portion to which the chemical liquid has been supplied; and supplying a rinse liquid for removing the second coating film to the peeling target portion after the amplification of the temperature fluctuation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a schematic configuration of a substrate processing system according to an exemplary embodiment.

FIG. 2 is a schematic view illustrating a schematic configuration of an example of a substrate processing apparatus.

FIG. 3 is a schematic view illustrating a modification of the substrate processing apparatus.

FIG. 4 is a schematic view illustrating another modification of the substrate processing apparatus.

FIG. 5 is a flowchart illustrating a substrate processing procedure.

FIG. 6 is a flowchart illustrating a procedure of a chemical liquid supplying process.

FIG. 7 is a flowchart illustrating a procedure of a temperature fluctuation amplifying process.

FIG. 8 is a flowchart illustrating a procedure of a rinsing process.

FIGS. 9A and 9B are schematic views illustrating the state of a wafer during the performance of the chemical liquid supplying process.

FIGS. 10A and 10B are schematic views illustrating the state of the wafer during the performance of the temperature fluctuation amplifying process.

FIGS. 11A and 11B are schematic views illustrating the state of the wafer during the performance of the rinsing process.

### DETAILED DESCRIPTION

In the following detailed description, reference is made to the accompanying drawings, which form a part of the present disclosure. The illustrative embodiments described in the detailed description, drawing, and claims are not meant to be in any way limiting. Other embodiments may be utilized, and other changes may be made without departing from the spirit or the scope of the subject matter presented here.

Hereinafter, an embodiment will be described in detail with reference to the drawings. In the descriptions, the same components or functions will be denoted by the same reference numerals, and overlapping descriptions thereof will be omitted.

[Substrate Processing System]

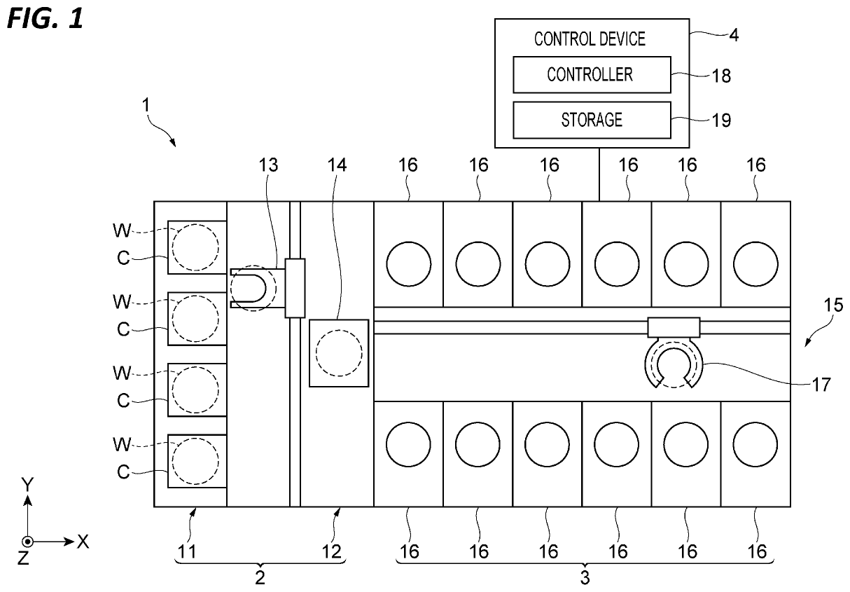

FIG. 1 is a view illustrating a schematic configuration of a substrate processing system according to the present embodiment. In the following, to clarify the positional relationship, the X axis, the Y axis, and the Z axis which are orthogonal to each other are defined, and the positive direction of the Z axis is the vertically upward direction. As illustrated in FIG. 1, a substrate processing system 1 includes a carry-in/out station 2 and a processing station 3. The carry-in/out station 2 and the processing station 3 are provided adjacent to each other.

The carry-in/out station 2 includes a carrier placement section 11 and a transfer section 12. In the carrier placement section 11, a plurality of carriers C are arranged to accommodate a plurality of substrates, i.e., semiconductor wafers (hereinafter, wafers W) in the present embodiment, in a horizontal state.

The transfer section 12 is provided adjacent to the carrier placement section 11, and includes a substrate transfer device 13 and a delivery unit 14 therein. The substrate transfer device 13 includes a wafer holding mechanism that holds the wafer W. In addition, the substrate transfer device 13 is movable horizontally and vertically and pivotable about the vertical axis, so as to transfer the wafer W between a carrier C and the delivery unit 14 using the wafer holding mechanism.

The processing station 3 is provided adjacent to the transfer section 12. The processing station 3 includes a transfer unit 15 and a plurality of processing units 16. The plurality of processing units 16 are arranged side by side on both sides of the transfer unit 15.

The transfer unit 15 includes a substrate transfer device 17 therein. The substrate transfer device 17 includes a wafer holding mechanism that holds the wafer W. In addition, the substrate transfer device 17 is movable horizontally and vertically and pivotable about the vertical axis, so as to transfer the wafer W between the delivery unit 14 and the processing units 16 using the wafer holding mechanism.

Each processing unit 16 performs a predetermined substrate processing on the wafer W transferred by the substrate transfer device 17.

The substrate processing system 1 further includes a control device 4. The control device 4 is, for example, a computer, and includes a controller 18 and a storage 19. The storage 19 stores programs for controlling various processes performed in the substrate processing system 1. The controller 18 controls the operation of the substrate processing system 1 by reading out and executing the programs stored in the storage 19.

In addition, the programs may be recorded in a computer-readable storage medium, and may be installed in the storage 19 of the control device 4 from the storage medium. Examples of the computer-readable storage medium are a hard disk (HD), a flexible disk (FD), a compact disk (CD), a magnet optical disk (MO), a memory card, etc.

In the substrate processing system 1 configured as described above, first, the substrate transfer device 13 of the carry-in/out station 2 takes out the wafer W from a carrier C placed on the carrier placement unit 11, and places the taken-out wafer W on the delivery unit 14. The wafer W placed on the delivery unit 14 is taken out of the delivery unit 14 by the substrate transfer device 17 of the processing station 3, and carried into a processing unit 16.

The wafer W carried into the processing unit 16 is processed by the processing unit 16, and then, carried out of the processing unit 16 by the substrate transfer device 17 to be placed on the delivery unit 14. Then, the processed wafer W placed on the delivery unit 14 is returned to the carrier C of the carrier placement unit 11 by the substrate transfer device 13.

[Substrate Processing Apparatus]

Subsequently, an example of a configuration of a substrate processing apparatus 10 included in the substrate processing system 1 will be described. The substrate processing apparatus 10 takes, as a processing target, a coating film F that includes a first coating film F1 formed on the surface of the wafer W and a second coating film F2 formed on the first coating film F1 with a different composition from that the first coating film F1, and performs a process of removing at least a portion of the second coating film F2 on the processing target. In addition, the first coating film F1 may be formed in contact with the surface of the wafer W, or may be formed on another coating film formed on the surface of the wafer W. Specific examples of the first coating film F1 may be a silicon-based film (e.g., a silicon nitride film a polysilicon film or the like), a metal containing film, etc. The second coating film F2 contains carbon. Specific examples of the second coating film F2 may be a hard mask for etching, a low dielectric constant (low-K) interlayer insulating film, etc.

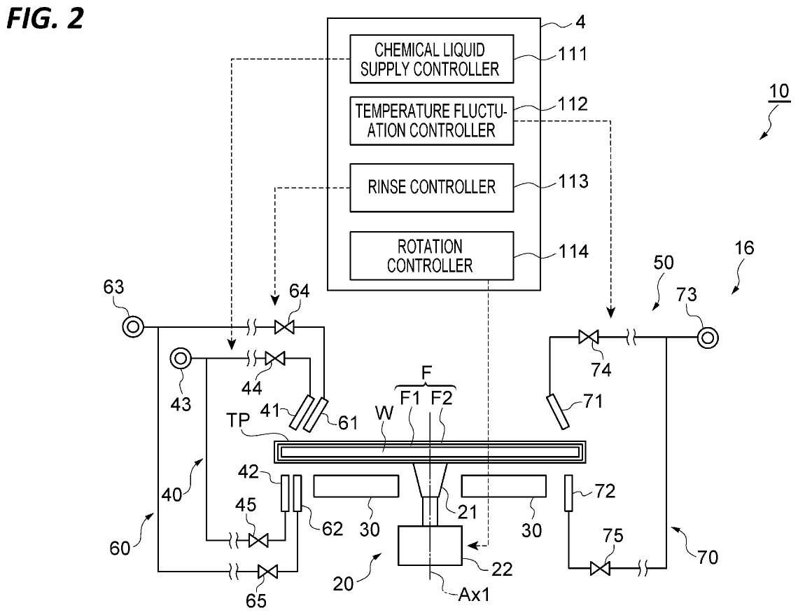

As illustrated in FIG. 2, the substrate processing apparatus 10 includes a processing unit 16 and a control device 4 that controls the processing unit 16. The processing unit 16 includes a rotation holder 20, a heater 30, a chemical liquid supply 40, a temperature fluctuation amplifier 50, and a rinse liquid supply 60.

The rotation holder 20 (substrate holder) holds and rotates the wafer W having the surface Wa on which the coating film F is formed. For example, the rotation holder 20 includes a holder 21 and a rotation driving unit 22. The holder 21 supports the wafer W placed horizontally with the coating film F facing upward, and holds the wafer W by, for example, vacuum suction or the like. The rotation driving unit 22 is an actuator using, for example, an electric motor as a driving source, and rotates the holder 21 and the wafer W around a vertical axis Ax1.

The heater 30 heats the wafer W held by the holder 21. For example, the heater 30 is disposed to face the lower surface of the wafer W held by the holder 21, and generates heat using a heating wire or the like as a heat source.

The chemical liquid supply 40 supplies a chemical liquid for enhancing the peeling performance between the first coating film F1 and the second coating film F2, to a peeling target portion which is at least a portion of the coating film F including the first coating film F1 and the second coating film F2 (e.g., the peripheral edge of the wafer W). The chemical liquid is, for example, a chemical liquid that has a permeability to the second coating film F2 and transforms the surface layer of the first coating film F1. Specific examples of the transformation may be a dissolution, a hardening, etc. Specific examples of the chemical liquid may be an aqueous solution of hydrogen fluoride (HF) (hydrofluoric acid), hydrochloric acid, an aqueous solution of ammonia (NH₃), etc. The chemical liquid supply 40 may not necessarily supply the chemical liquid in the liquid form, and may supply the chemical liquid in a vaporized state.

For example, the chemical liquid supply 40 includes an upper nozzle 41, a lower nozzle 42, a chemical liquid supply source 43, and valves 44 and 45. The upper nozzle 41 is disposed above the wafer W, and ejects the chemical liquid toward the upper surface of the wafer W. The lower nozzle 42 is disposed below the wafer W, and ejects the chemical liquid toward the lower surface of the wafer W. The chemical liquid supply source 43 supplies the chemical liquid to the upper nozzle 41 and the lower nozzle 42. For example, the chemical liquid supply source 43 includes a tank (not illustrated) that accommodates the chemical liquid, and a pump (not illustrated) that pumps the chemical liquid from the tank to the upper nozzle 41 and the lower nozzle 42. The valves 44 and 45 are, for example, air operation valves, and open/close flow paths of the chemical liquid from the chemical liquid supply source 43 to the upper nozzle 41 and the lower nozzle 42, respectively.

The temperature fluctuation amplifier 50 amplifies a temperature fluctuation of the peeling target portion TP to which the chemical liquid has been supplied. Amplifying the temperature fluctuation after the supply of the chemical liquid indicates increasing the difference between the maximum value and the minimum value of the temperature of the peeling target portion TP to which the chemical liquid has been supplied.

When the temperature fluctuation of the peeling target portion TP is amplified, the peeling between the first coating film F1 and the second coating film F2 may be progressed. For example, when the first coating film F1 and the second coating film F2 have different expansion (or contraction) rates caused from the temperature fluctuation, the peeling between the first coating film F1 and the second coating film F2 may be progressed as a result. The temperature fluctuation amplifier 50 amplifies the temperature fluctuation of the peeling target portion TP to a level at which the progress of the peeling actually occurs. For example, the temperature fluctuation amplifier 50 amplifies the temperature fluctuation to 150° C. to 300° C. That is, the temperature fluctuation amplifier 50 amplifies the temperature fluctuation of the peeling target portion TP until the difference between the maximum value and the minimum value of the temperature of the peeling target portion TP becomes 150° C. to 300° C.

For example, the temperature fluctuation amplifier 50 includes a fluid supply 70 that supplies a fluid for amplifying the temperature fluctuation (hereinafter, referred to as a “temperature fluctuation fluid”) to the peeling target portion TP. The temperature fluctuation fluid may be a liquid or gas. Further, the temperature fluctuation fluid may be a fluid that cools the peeling target portion TP or a fluid that heats the peeling target portion TP. A specific example of the fluid that cools the peeling target portion TP may be liquid nitrogen. Further, the fluid that cools the peeling target portion TP may be a solvent that takes away the vaporization heat to cool the peeling target portion TP (e.g., thinner or the like). A specific example of the fluid that heats the peeling target portion TP may be hot water.

For example, the fluid supply 70 includes an upper nozzle 71, a lower nozzle 72, a fluid supply source 73, and valves 74 and 75. The upper nozzle 71 is disposed above the wafer W, and ejects the temperature fluctuation fluid toward the upper surface of the wafer W. The lower nozzle 72 is disposed below the wafer W, and ejects the temperature fluctuation fluid toward the lower surface of the wafer W. The fluid supply source 73 supplies the temperature fluctuation fluid to the upper nozzle 71 and the lower nozzle 72. For example, the fluid supply source 73 includes a tank (not illustrated) that accommodates the temperature fluctuation fluid, and a pump (not illustrated) that pumps the temperature fluctuation fluid from the tank to the upper nozzle 71 and the lower nozzle 72. The valves 74 and 75 are, for example, air operation valves, and open/close flow paths of the fluid from the fluid supply source 73 to the upper nozzle 71 and the lower nozzle 72, respectively.

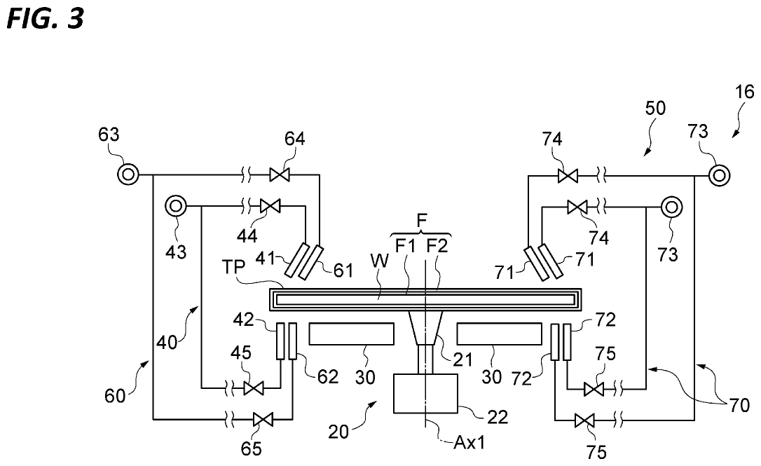

The fluid that heats the peeling target portion TP may be two types of fluids that generate or absorb heat by being mixed with each other. In this case, as illustrated in FIG. 3, the temperature fluctuation amplifier 50 may have a two-system fluid supply 70 that supplies two types of fluids. Specific examples of the first type of fluid may be hydrogen peroxide water, hydrofluoric acid, hydrochloric acid, etc. When the first type of fluid is hydrogen peroxide water or hydrofluoric acid, a specific example of the second type of fluid may be sulfuric acid. When the first type of fluid is hydrochloric acid, a specific example of the second type fluid may be a nitric acid aqueous solution.

The rinse liquid supply 60 supplies a rinse liquid for removing the second coating film F2 to the peeling target portion TP. Specific examples of the rinse liquid may be deionized water or the like. For example, the rinse liquid supply 60 includes an upper nozzle 61, a lower nozzle 62, a rinse liquid supply source 63, and valves 64 and 65. The upper nozzle 61 is disposed above the wafer W, and ejects the rinse liquid toward the upper surface of the wafer W. The lower nozzle 62 is disposed below the wafer W, and ejects the rinse liquid toward the lower surface of the wafer W. The rinse liquid supply source 63 supplies the rinse liquid to the upper nozzle 61 and the lower nozzle 62. For example, the rinse liquid supply source 63 includes a tank (not illustrated) that accommodates the rinse liquid, and a pump (not illustrated) that pumps the rinse liquid from the tank to the upper nozzle 61 and the lower nozzle 62. The valves 64 and 65 are, for example, air operation valves, and open/close flow paths of the rinse liquid from the rinse liquid supply source 63 to the upper nozzle 61 and the lower nozzle 62, respectively. In addition, the rinse liquid supply 60 may be configured to supply the rinse liquid in a state of being heated to the room temperature or higher.

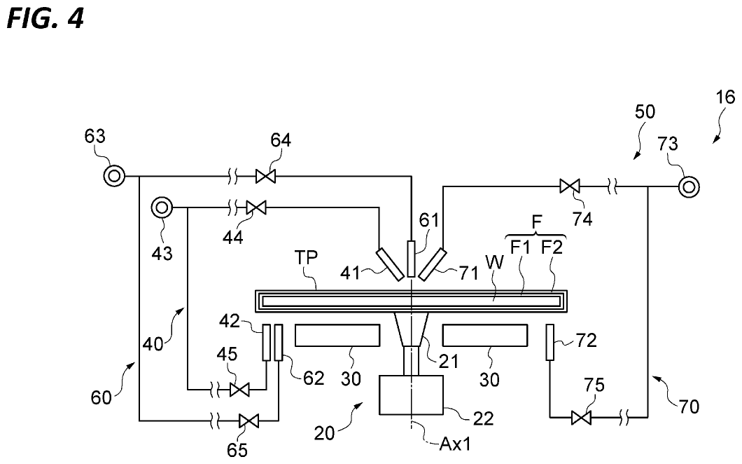

In addition, the peeling target portion TP is not necessarily limited to the peripheral edge of the wafer W. For example, the entire upper surface of the wafer W may be the peeling target portion TP. In this case, the chemical liquid supply 40, the fluid supply 70, and the rinse liquid supply 60 are configured to supply the chemical liquid, the temperature fluctuation fluid, and the rinse liquid to the entire upper surface of the wafer W, as illustrated in FIG. 4. In FIG. 4, the upper nozzles 41, 61, and 71 are disposed toward the center of the wafer W, such that each of the chemical liquid, the temperature fluctuation fluid, and the rinse liquid is supplied to the center of the upper surface of the wafer W. The chemical liquid, the temperature fluctuation fluid, and the rinse liquid that have reached the center of the upper surface of the wafer W, spread over the entire upper surface of the wafer W by the rotation of the wafer W.

The control device 4 is configured to perform the following three controls. The first control is to control the chemical liquid supply 40 so as to supply the chemical liquid for enhancing the peeling performance between the first coating film F1 and the second coating film F2, to the peeling target portion TP. The second control is to control the temperature fluctuation amplifier 50 so as to amplify the temperature fluctuation of the peeling target portion TP to which the chemical liquid has been supplied. The third control is to control the rinse liquid supply 60 so as to supply the rinse liquid to the peeling target portion TP, after the amplification of the temperature fluctuation.

For example, the control device 4 includes a chemical liquid supply controller 111, a temperature fluctuation controller 112, a rinse controller 113, and a rotation controller 114 as functional components (hereinafter, referred to as “functional modules”). The chemical liquid supply controller 111 controls the chemical liquid supply 40 to supply the chemical liquid to the peeling target portion TP. The temperature fluctuation controller 112 controls the temperature fluctuation amplifier 50 to supply the fluid for amplifying the temperature fluctuation to the peeling target portion TP to which the chemical liquid has been supplied. The temperature fluctuation controller 112 may control the temperature fluctuation amplifier 50 to supply a cooling fluid to the peeling target portion TP in a state where the heater 30 is heating the wafer W. The rinse controller 113 controls the rinse liquid supply 60 to supply the rinse liquid to the peeling target portion TP, after the amplification of the temperature fluctuation of the peeling target portion TP. The rotation controller 114 controls the rotation holder 20 to rotate the wafer W at a preset rotation speed.

[Substrate Processing Method]

Subsequently, a procedure of the substrate processing performed by the substrate processing apparatus 10 will be described as an example of the substrate processing method. The procedure of the substrate processing includes supplying the chemical liquid to the peeling target portion TP, amplifying the temperature fluctuation of the peeling target portion TP to which the chemical liquid has been supplied; and supplying the rinse liquid to the peeling target portion TP, after the amplification of the temperature fluctuation. Amplifying the temperature fluctuation of the peeling target portion TP may include supplying the temperature fluctuation fluid to the peeling target portion TP. Supplying the temperature fluctuation fluid to the peeling target portion TP may include supplying a cooling fluid to the peeling target portion TP in a state where the wafer W has been heated by the heater 30.

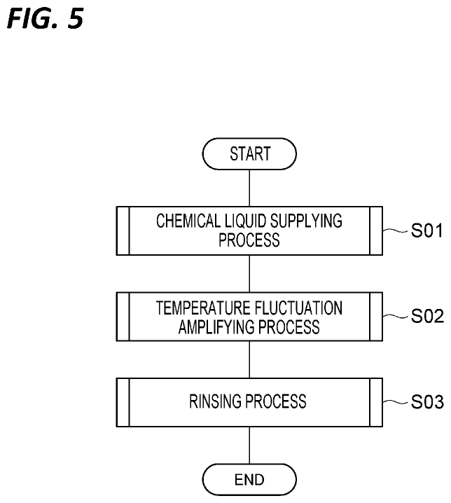

In the substrate processing procedure, the control device 4 sequentially performs steps S01, S02, and S03 as illustrated in FIG. 5. In step S01, the chemical liquid supply controller 111 and the rotation controller 114 control the processing unit 16 to perform a process of supplying the chemical liquid to the peeling target portion TP (hereinafter, referred to as a “chemical liquid supplying process”). In step S02, the temperature fluctuation controller 112 and the rotation controller 114 control the processing unit 16 to perform a process of amplifying the temperature fluctuation of the peeling target portion TP (hereinafter, referred to as a “temperature fluctuation amplifying process”). In step S03, the rinse controller 113 and the rotation controller 114 control the processing unit 16 to perform a process of supplying the rinse liquid to the peeling target portion TP (hereinafter, referred to as a “rinsing process”). Hereinafter, specific contents of the chemical liquid supplying process of step S01, the temperature fluctuation amplifying process of step S02, and the rinsing process of step S03 will be described.

[Chemical Liquid Supplying Process]

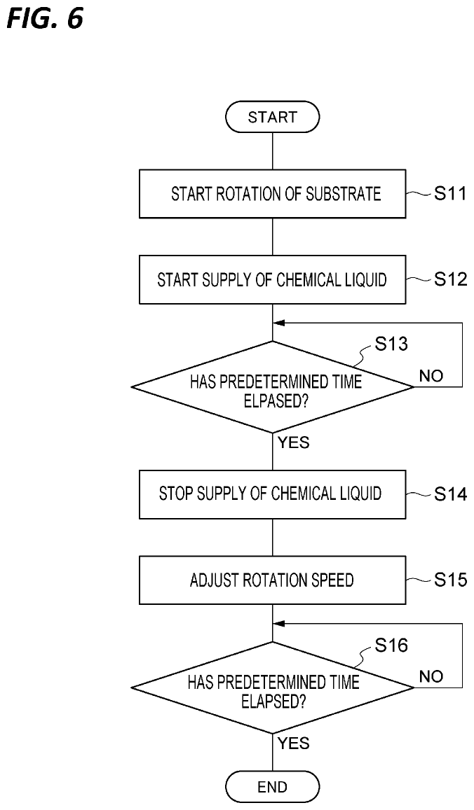

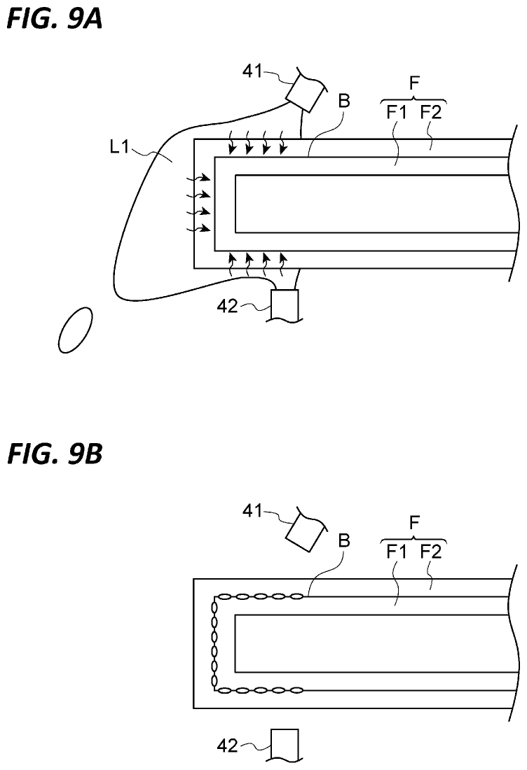

Subsequently, an example of a specific procedure of the chemical liquid supplying process in step S01 will be described. As illustrated in FIG. 6, the control device performs steps S11, S12, and S13. In step S11, the rotation controller 114 controls the rotation holder 20 to start the rotation of the wafer W and adjust the rotation speed of the wafer W to a preset rotation speed for the supply of the chemical liquid. In step S12, the chemical liquid supply controller 111 controls the chemical liquid supply 40 to open the valves 44 and 45 and start the ejection of the chemical liquid from the upper nozzle 41 and the lower nozzle 42. Thereafter, the chemical liquid supply controller 111 controls the chemical liquid supply 40 to continue the ejection of the chemical liquid from the upper nozzle 41 and the lower nozzle 42 at a predetermined flow rate. The predetermined flow rate is, for example, 10 ml/min to 20 ml/min as the total flow rate of the upper nozzle 41 and the lower nozzle 42. In step S13, the chemical liquid supply controller 111 controls the chemical liquid supply 40 to continue the ejection of the chemical liquid from the upper nozzle 41 and the lower nozzle 42 until a predetermined time for the supply of the chemical liquid elapses. The time for the supply of the chemical liquid is, for example, 100 seconds to 300 seconds, and may be 150 seconds to 200 seconds (e.g., 180 seconds). At this time, as illustrated in FIGS. 9A and 9B, the chemical liquid L1 supplied to the peeling target portion TP penetrates into the second coating film F2 to reach the boundary B between the first coating film F1 and the second coating film F2 (FIG. 9A), and transforms the surface layer of the first coating film F1 (FIG. 9B). As a result, the peeling performance between the first coating film F1 and the second coating film F2 is enhanced.

Subsequently, the control device 4 performs steps S14, S15, and S16. In step S14, the chemical liquid supply controller 111 controls the chemical liquid supply 40 to close the valves 44 and 45 and stop the ejection of the chemical liquid from the upper nozzle 41 and the lower nozzle 42. In step S15, the rotation controller 114 controls the rotation holder 20 to adjust the rotation speed of the wafer W to a preset rotation speed for shaking-off/drying. In step S16, the rotation controller 114 controls the rotation holder 20 to continue the rotation of the wafer W at the rotation speed for shaking-off/drying until a preset drying time elapses. The drying time is, for example, 5 seconds to 20 seconds, and may be 5 seconds to 15 seconds (e.g., 10 seconds). In this way, the chemical liquid supplying process is completed.

[Temperature Fluctuation Amplifying Process]

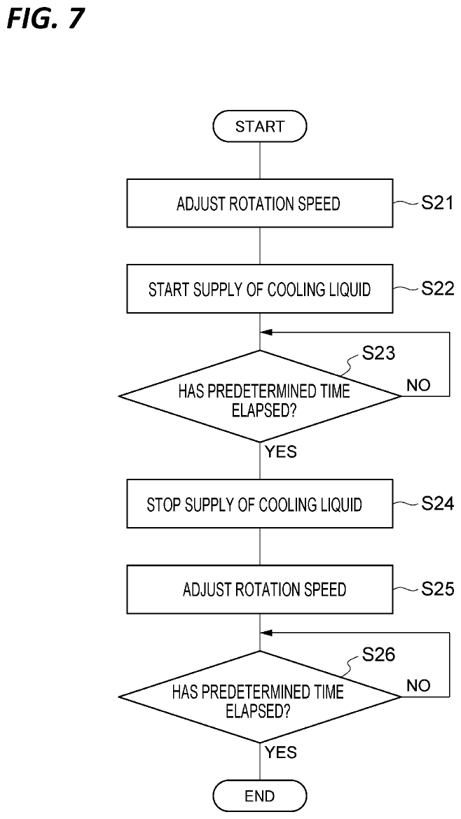

Subsequently, an example of a specific procedure of the temperature fluctuation amplifying process in step S02 will be described. As illustrated in FIG. 7, the control device 4 performs steps S21 and S22. In step S21, the rotation controller 114 controls the rotation holder 20 to adjust the rotation speed of the wafer W to a preset rotation speed for the supply of a fluid (for the supply of the temperature fluctuation fluid). In step S22, the temperature fluctuation controller 112 controls the fluid supply 70 to open the valves 74 and 75 and start the ejection of the temperature fluctuation fluid from the upper nozzle 71 and the lower nozzle 72. Thereafter, the temperature fluctuation controller 112 controls the fluid supply 70 to continue the ejection of the temperature fluctuation fluid from the upper nozzle 71 and the lower nozzle 72 at a predetermined flow rate. The predetermined flow rate may be larger than the above-described flow rate of the chemical liquid from the upper nozzle 71 and the lower nozzle 72. For example, the predetermined flow rate may be 100 ml/min to 1,000 ml/min or 300 ml/min to 700 ml/min (e.g., 500 ml/min) as the total flow rate of the upper nozzle 71 and the lower nozzle 72. The temperature fluctuation controller 112 may control the fluid supply 70 to supply a cooling fluid (e.g., liquid nitrogen) to the peeling target portion TP in a state where the wafer W is being heated by the heater 30. The temperature of the chemical liquid, the temperature of the heater 30, and the temperature of the cooling fluid may be set so as to amplify the temperature fluctuation of the peeling target portion TP to 150° C. to 300° C. As for a specific example of the temperature setting, the temperature of the chemical liquid may be set to 10° C. to 40° C. (e.g., room temperature), the setting temperature of the heater 30 may be 100° C. to 200° C., and the temperature of the cooling fluid may be set to −270° C. to −100° C. (e.g., −200° C.).

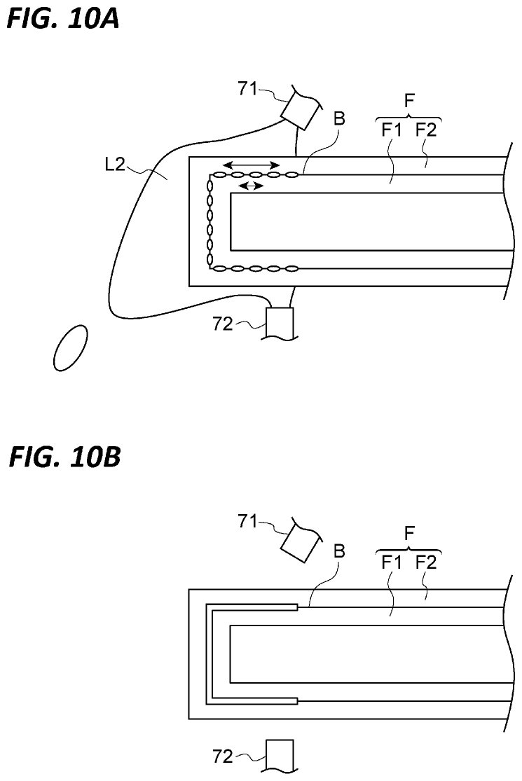

Subsequently, the control device 4 performs step S23. In step S23, the temperature fluctuation controller 112 controls the fluid supply 70 to continue the ejection of the temperature fluctuation fluid from the upper nozzle 71 and the lower nozzle 72 until a preset time for the temperature fluctuation elapses. The time for the temperature fluctuation may be shorter than the time for the supply of the chemical liquid. For example, the time for the temperature fluctuation may be 10 seconds to 110 seconds or may be 30 seconds to 90 seconds (e.g., 60 seconds). At this time, as illustrated in FIGS. 10A and 10B, when a temperature fluctuation fluid L2 is supplied to the peeling target portion TP, an expansion or contraction occurs due to the temperature fluctuation in each of the first coating film F1 and the second coating film F2. Since the expansion (or contraction) rates of the first coating film F1 and the second coating film F2 are different from each other, a stress is intensively applied to the boundary B between the first coating film F1 and the second coating film F2 (FIG. 10A). As a result, the peeling between the first coating film F1 and the second coating film F2 is progressed (FIG. 10B).

Subsequently, the control device 4 performs steps S24, S25, and S26. In step S24, the temperature fluctuation controller 112 controls the fluid supply 70 to close the valves 74 and 75 and stop the ejection of the temperature fluctuation fluid from the upper nozzle 71 and the lower nozzle 72. In step S25, the rotation controller 114 controls the rotation holder 20 to adjust the rotation speed of the wafer W to a preset rotation speed for shaking-off/drying. In step S26, the rotation controller 114 controls the rotation holder 20 to continue the rotation of the wafer W at the rotation speed for shaking-off/drying until a preset drying time elapses. The drying time may be, for example, 5 seconds to 20 seconds or 5 seconds to 15 seconds (e.g., 10 seconds). In this way, the temperature fluctuation amplifying process is completed.

In addition, the temperature fluctuation controller 112 and the rotation controller 114 may repeat steps S21 to S26 a preset number of times. For example, when the cooling fluid is supplied in a state where the wafer W is being heated by the heater 30, the cooling of the peeling target portion TP (the cooling by the cooling fluid) and the heating of the peeling target portion TP (the heating by the heater 30 via the wafer W) are repeated by the repeated performance of steps S21 to S26. By the repeated cooling and heating, the peeling between the first coating film F1 and the second coating film F2 may be further progressed.

[Rinsing Process]

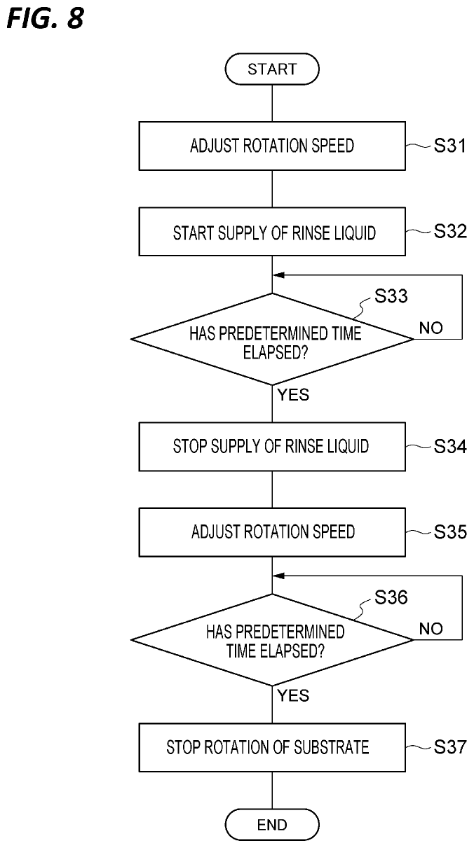

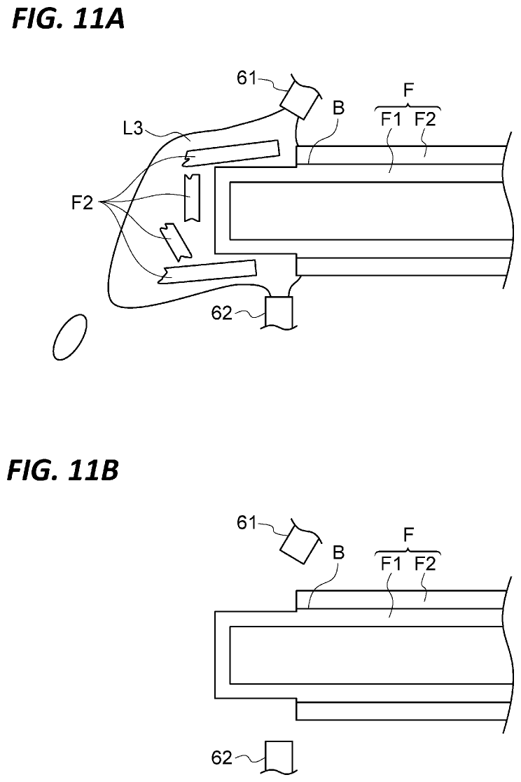

Subsequently, an example of a specific procedure of the rinsing process in step S03 will be described. As illustrated in FIG. 8, the control device 4 performs steps S31, S32, and S33. In step S31, the rotation controller 114 controls the rotation holder 20 to adjust the rotation speed of the wafer W to a preset rotation speed for the supply of the rinse liquid. In step S32, the rinse controller 113 controls the rinse liquid supply 60 to open the valves 64 and 65 and start the ejection of the rinse liquid from the upper nozzle 61 and the lower nozzle 62. Thereafter, the rinse controller 113 controls the rinse liquid supply 60 to continue the ejection of the rinse liquid from the upper nozzle 61 and the lower nozzle 62 at a predetermined flow rate. The predetermined flow rate is, for example, 10 ml/min to 20 ml/min as the total flow rate of the upper nozzle 61 and the lower nozzle 62. The rinse controller 113 may control the rinse liquid supply 60 to supply the rinse liquid to the peeling target portion TP in a state where the wafer W is being heated by the heater 30. In this case, the temperature of the rinse liquid that reaches the peeling target portion TP is increased, so that the operation to remove the second coating film F2 is improved. In step S33, the rinse controller 113 controls the rinse liquid supply 60 to continue the ejection of the rinse liquid from the upper nozzle 61 and the lower nozzle 62 until a preset time for the supply of the rinse liquid elapses. The time for the supply of the rinse liquid may be, for example, 10 seconds to 110 seconds or may be 30 seconds to 90 seconds (e.g., 60 seconds). As described above, the peeling between the second coating film F2 and the first coating film F1 is being progressed in the peeling target portion TP. Thus, as illustrated in FIG. 11A, the second coating film F2 is removed by a rinse liquid L3 in the peeling target portion TP. FIG. 11B illustrates the wafer W in a state where the second coating film F2 has been removed in the peeling target portion TP.

Subsequently, the control device 4 performs steps S34, S35, S36, and S37. In step S34, the rinse controller 113 controls the rinse liquid supply 60 to close the valves 64 and 65 and stop the ejection of the rinse liquid from the upper nozzle 61 and the lower nozzle 62. In step S35, the rotation controller 114 controls the rotation holder 20 to adjust the rotation speed of the wafer W to a preset rotation speed for shaking-off/drying. In step S36, the rotation controller 114 controls the rotation holder 20 to continue the rotation of the wafer W at the rotation speed for shaking-off/drying until a preset drying time elapses. The drying time may be, for example, 5 seconds to 20 seconds or may be 5 seconds to 15 seconds (e.g., 10 seconds). In step S37, the rotation controller 114 controls the rotation holder 20 to stop the rotation of the wafer W. In this way, the rinsing process is completed.

[Effects of the Present Embodiment]

As described above, the substrate processing method according to the exemplary embodiment includes supplying, to a peeling target portion which is at least a portion of the coating film F including the first coating film F1 and the second coating film F2, the chemical liquid for enhancing the peeling performance between the first coating film F1 and the second coating film F2, the first coating film F1 being formed on the surface of the wafer W, the second coating film F2 being formed on the first coating film and containing carbon with a different composition from that of the first coating film F1; amplifying the temperature fluctuation of the peeling target portion TP to which the chemical liquid has been supplied; and supplying a rinse liquid for removing the second coating film F2 to the peeling target portion TP after the amplification of the temperature fluctuation.

The coating film F that contains carbon tends to be hardly dissolved by the chemical liquid. In this regard, according to the substrate processing method of the present disclosure, the temperature fluctuation of the peeling target portion TP is amplified in a state where the peeling performance between the first coating film F1 and the second coating film F2 in the peeling target portion TP is enhanced. Since the composition of the first coating film F1 and the composition of the second coating film F2 are different from each other, the behavior of the first coating film F1 by the amplification of the temperature fluctuation and the behavior of the second coating film F2 by the amplification of the temperature fluctuation are also different from each other. Due to the difference in behavior, a stress is intensively applied to the boundary between the first coating film F1 and the second coating film F2. Since the stress is intensively applied to the boundary between the first coating film F1 and the second coating film F2 in the state where the peeling performance between the first coating film F1 and the second coating film F2 is enhanced, the peeling between the first coating film F1 and the second coating F2 is promoted. Thus, even in a state where the second coating film F2 is not dissolved, the second coating film F2 may be removed by the rinse liquid. Accordingly, the present disclosure is effective for implementing the removal of the coating film F that contains carbon by a liquid processing.

The chemical liquid may be a chemical liquid that has a permeability to the second coating film F2 and transforms the surface layer of the first coating film F1. In this case, the peeling performance between the first coating film F1 and the second coating film F2 may be more reliably enhanced.

Amplifying the temperature fluctuation of the peeling target portion TP may include supplying the fluid for amplifying the temperature fluctuation to the peeling target portion TP. In this case, the temperature fluctuation may be amplified with a simple configuration.

Supplying the fluid for amplifying the temperature fluctuation to the peeling target portion TP may include supplying the cooling fluid to the peeling target portion TP in a state where the wafer W is heated by the heater. In this case, the temperature fluctuation may be further amplified.

The fluid may be liquid nitrogen. In this case, the temperature may be rapidly changed by a rapid cooling, so that the peeling between the first coating film F1 and the second coating film F2 may be more reliably promoted.

The temperature fluctuation of the peeling target portion may be amplified to 150° C. to 300° C. In this case, the peeling between the first coating film F1 and the second coating F2 may be more reliably promoted.

The peeling target portion TP may be the peripheral edge of the coating film F. In the removal of the coating film F by the liquid processing using the chemical liquid, the range of the peeling target portion TP may be easily adjusted by adjusting the supply range of the chemical liquid. Thus, when the peeling target portion TP is limited to the peripheral edge of the coating film F, the removal of the coating film F by the liquid processing may be more effectively implemented.

While the embodiment of the present disclosure has been described, the present disclosure is not necessarily limited to the embodiment, and may be modified in various ways in the scope that does not depart from the gist of the present disclosure. For example, the substrate as a processing target is not limited to a semiconductor wafer, and may be, for example, a glass substrate, a mask substrate, a flat panel display (FPD) or the like.

### Example

Subsequently, an Experimental Example for simulating the substrate processing procedure described above will be described, but the present disclosure is not limited to the Example described herein. First, a test piece was prepared by forming the first coating film F1 and the second coating film F2 on a base material as follows.

Base material: Silicon substrate

First coating film F1: Silicon dioxide film having a 5 nm thickness

Second coating film F2: Amorphous carbon film having a 1.3 μm thickness

Next, the test piece was immersed in hydrofluoric acid for 180 seconds, and then, dried. Next, the test piece was immersed in liquid nitrogen for 60 seconds, and then, dried. Next, the test piece was immersed in 60° C. hot water for 60 seconds, and then, dried.

As a result of observing the test piece that has been subjected to the processing described above, it was confirmed that the second coating film F2 was removed. In addition, the first coating film F1 remained on the test piece. From the test result, it was confirmed that the second coating film F2 that contains carbon may be removed by the liquid processing according to the substrate processing procedure described above.

According to then exemplary embodiment of the present disclosure, it is possible to provide a substrate processing method, a substrate processing apparatus, and a storage medium which are effective for implementing the removal of a carbon-containing coating film by a liquid processing.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate processing method comprising:
supplying, to a peeling target portion which is at least a portion of a coating film including a first coating film and a second coating film, a chemical liquid for enhancing a peeling performance between the first coating film and the second coating film, the first coating film being formed on a surface of a substrate, and the second coating film being formed on the first coating film and containing carbon with a different composition from that of the first coating film;
amplifying a temperature fluctuation of the peeling target portion to which the chemical liquid has been supplied; and
supplying a rinse liquid for removing the second coating film to the peeling target portion after the amplifying the temperature fluctuation.

2. The substrate processing method according to claim 1, wherein the chemical liquid has a permeability to the second coating film and transforms a surface layer of the first coating film.

3. The substrate processing method according to claim 2, wherein the amplifying the temperature fluctuation of the peeling target portion includes supplying a fluid for amplifying the temperature fluctuation to the peeling target portion.

4. The substrate processing method according to claim 3, wherein the supplying the fluid for amplifying the temperature fluctuation to the peeling target portion includes supplying a cooling fluid to the peeling target portion in a state where the substrate is heated by a heater.

5. The substrate processing method according to claim 3, wherein the fluid is liquid nitrogen.

6. The substrate processing method according to claim 3, wherein the temperature fluctuation of the peeling target portion is amplified to 150° C. to 300° C.

7. The substrate processing method according to claim 3, wherein the peeling target portion is a peripheral edge of the coating film.

8. The substrate processing method according to claim 2, wherein the temperature fluctuation of the peeling target portion is amplified to 150° C. to 300° C.

9. The substrate processing method according to claim 2, wherein the peeling target portion is a peripheral edge of the coating film.

10. The substrate processing method according to claim 1, wherein the amplifying the temperature fluctuation of the peeling target portion includes supplying a fluid for amplifying the temperature fluctuation to the peeling target portion.

11. The substrate processing method according to claim 10, wherein the supplying the fluid for amplifying the temperature fluctuation to the peeling target portion includes supplying a cooling fluid to the peeling target portion in a state where the substrate is heated by a heater.

12. The substrate processing method according to claim 10, wherein the fluid is liquid nitrogen.

13. The substrate processing method according to claim 10, wherein the temperature fluctuation of the peeling target portion is amplified to 150° C. to 300° C.

14. The substrate processing method according to claim 10, wherein the peeling target portion is a peripheral edge of the coating film.

15. The substrate processing method according to claim 6, wherein the temperature fluctuation of the peeling target portion is amplified to 150° C. to 300° C.

16. The substrate processing method according to claim 15, wherein the peeling target portion is a peripheral edge of the coating film.

17. A substrate processing apparatus comprising:
a substrate holder configured to hold a substrate;
a chemical liquid supply configured to supply, to a peeling target portion which is at least a portion of a coating film including a first coating film and a second coating film, a chemical liquid for enhancing a peeling performance between the first coating film and the second coating film, the first coating film being formed on a surface of a substrate, and the second coating film being formed on the first coating film;
a temperature fluctuation amplifier configured to amplify a temperature fluctuation of the peeling target portion to which the chemical liquid has been supplied; and
a rinse liquid supply configured to supply a rinse liquid for removing the second coating film to the peeling target portion.

18. The substrate processing apparatus according to claim 17, wherein the temperature fluctuation amplifier includes a fluid supply configured to supply a fluid for amplifying the temperature fluctuation to the peeling target portion.

19. A non-transitory computer-readable storage medium storing a program that causes a computer to perform the substrate processing method according to claim 1.
